(19) United States
(12) Patent Application Publication
(10) Pub. No.: US 2015/0065214 A1
(43) Pub. Date: Mar. 5, 2015

(54) Systems and Methods for Providing Statistical and Crowd Sourced Predictions

(71) Applicant: StatSims, LLC, Defiance, OH (US)

(72) Inventors: Steven A. Olson, Defiance, OH (US); Michael Cloran, Zionsville, IN (US); Brian Deyo, Carmel, IN (US); Daryn Shapurji, Carmel, IN (US); Jason Pitcher, Indianapolis, IN (US)

(73) Assignee: StatSims, LLC, Defiance, OH (US)

(21) Appl. No.: 14/014,518

(22) Filed: Aug. 30, 2013

(51) Int. Cl. A63F 13/00

(52) U.S. Cl. CPC A63F 13/00
USPC 463/9

(57) ABSTRACT

Included are embodiments for providing statistical and crowd sourced predictions that includes a memory component that stores logic that causes the system to determine default player ratings for a plurality of players based on statistical data, receive user player rankings from a plurality of users, and convert the user player rankings into user ratings. In some embodiments, the logic causes the system to determine team data for a plurality of teams, where each of the plurality of teams includes a player that has been rated and simulate a game between at least two of the plurality of teams, and where the simulation is made based on the default player ratings, the user ratings, and the team data. In some embodiments, the logic causes the system to determine an outcome of the game from the simulation and provide the outcome to the plurality of users for display.

### BACKGROUND

1. Field

Embodiments disclosed herein generally relate to providing statistical and crowd sourced predictions, and particularly to providing accurate predictions of sporting and other events.

2. Technical Background

As sports and other events have increased in popularity, various fan-based activities have developed to add to the game experience. As an example, many sports now have a “fantasy league” associated therewith. Fantasy leagues are generally created to provide fantasy league players the ability to draft athletes from a predetermined sports league onto their fantasy team. Based on those athletes' actual performance during the season, the fantasy players' team may perform better or worse. Similarly, many wagering opportunities are now being provided with these events. Wagering players may place a wager on a team, for a player, or on other outcomes of the event. As a consequence of those developments, there is now an increased desire for accurate predicting of the outcome of the events to perform better at these fan-based activities.

### SUMMARY

Included are embodiments for providing statistical and crowd sourced predictions that includes a memory component that stores logic that causes the system to determine default player ratings for a plurality of players based on statistical data, receive user player rankings from a plurality of users, and convert the user player rankings into user ratings. In some embodiments, the logic causes the system to determine team data for a plurality of teams, where each of the plurality of teams includes a player that has been rated and simulate a game between at least two of the plurality of teams, and where the simulation is made based on the default player ratings, the user ratings, and the team data. In some embodiments, the logic causes the system to determine an outcome of the game from the simulation and provide the outcome to the plurality of users for display

In another embodiment, a method for providing statistical and crowd sourced predictions may include determining default player ratings based on statistical data, receiving player rankings from a plurality of users, and converting the player rankings into user ratings. In some embodiments the method includes determining a rating for a first subset of a first team and a second subset of a second team, determining a first play strategy for the first subset and a second play strategy for the second subset. In some embodiments, the method includes simulating a game between the first subset and the second subset based on the first play strategy, the second play strategy, the default player ratings, and the user ratings, determining an outcome of the game from the simulation, and providing the outcome to the plurality of users for display.

In yet another embodiment, a non-transitory computer-readable medium for providing statistical and crowd sourced predictions may include logic that causes a computing device to determine a first rating for a first team and a second rating for a second team, simulate a game between the first team and the second team, and determine an outcome from the simulation. In some embodiments, the logic causes the computing device to determine a predicted wagering outcome of the game between the first team and the second team, compare the predicted wagering outcome with the simulation to determine a wagering strategy for the game, determine a confidence level of the wagering strategy, and provide the wagering strategy and the confidence level to a user for display.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for providing statistical and crowd sourced predictions, according to embodiments disclosed herein;

FIG. 2 depicts a remote computing device for providing statistical and crowd sourced predictions, according to one or more embodiments shown and described herein;

FIG. 3 depicts a user interface for providing default player ratings, according to one or more embodiments shown and described herein;

FIG. 4 depicts a user interface for providing user ranking options for players, according to one or more embodiments shown and described herein;

FIG. 5 depicts a user interface for providing a prediction of a specific player, according to one or more embodiments shown and described herein;

FIG. 6 depicts a user interface for providing a player performance variance, according to one or more embodiments shown and described herein;

FIG. 7 depicts a user interface for providing actual performance information of a player, according to one or more embodiments shown and described herein;

FIG. 8 depicts a user interface for providing a user scorecard for player and team prediction, according to one or more embodiments shown and described herein;

FIG. 9 depicts a user interface for simulating a game based on user rankings, according to one or more embodiments shown and described herein;

FIG. 10 depicts a user interface for simulating a game based on crowd sourcing, according to one or more embodiments shown and described herein;

FIG. 11 depicts a user interface for simulating a game based on statistical analysis, according to one or more embodiments shown and described herein;

FIG. 12 depicts a user interface for simulating a game based on user predicted strategies, according to one or more embodiments shown and described herein;

FIG. 13 depicts a user interface for providing wagering predictions for a game, according to one or more embodiments shown and described herein;

FIG. 14 depicts a user interface for providing wagering results for a past game, according to one or more embodiments shown and described herein;

FIG. 15 depicts a flowchart for simulating a game based on statistical data and crowd sourcing data, according to one or more embodiments shown and described herein;

FIG. 16 depicts a flowchart for simulating a portion of a game, based on performance in that game, according to one or more embodiments shown and described herein; and

FIG. 17 depicts a flowchart for determining a wagering strategy for a game, according to one or more embodiments shown and described herein.

### DETAILED DESCRIPTION

Embodiments disclosed herein relate to an online event prediction system that utilizes historical statistical data and/or crowd sourcing data to make predictions. As an example, professional sports, such as professional football may have “fantasy football leagues” that fans may join to add to the enjoyment of the games. A fantasy football league may allow fantasy players to draft and trade actual professional football players as part of the fantasy league rules. Based on the professional football players' performances, the fantasy players may score points and/or achieve rankings. Accordingly, the ability to accurately predict which professional football players will perform well during a game or season is of value to the fantasy players.

Similarly, when wagering on outcomes of events such as football games, a bettor desires to know, not only how a team or player will perform, but the outcome of a game in relation to “the spread,” which represented a book maker's prediction of the outcome of a game. Accordingly, embodiments disclosed herein utilize statistical data, as well as crowd sourcing data to predict an outcome to a game relative to the spread, as well as a confidence level for that prediction.

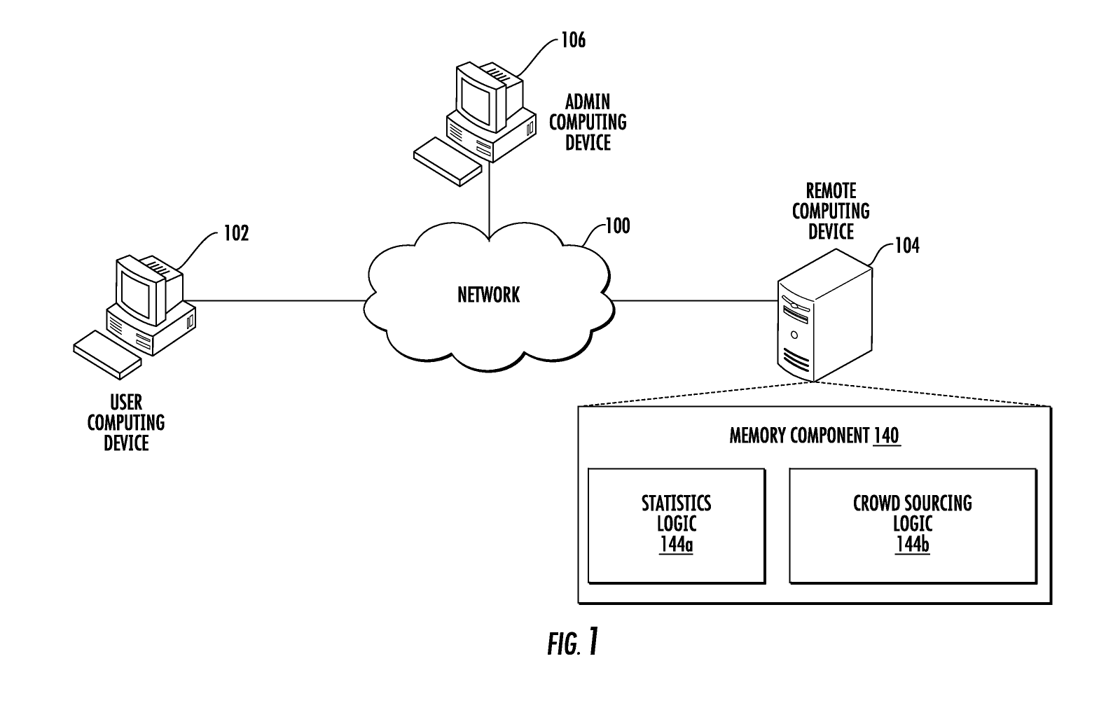

Referring now to the drawings, FIG. 1 depicts a computing environment for providing statistical and crowd sourced predictions, according to embodiments disclosed herein. As illustrated, a network 100 may be coupled to a user computing device 102, a remote computing device 104, and an administrator computing device 106. The network 100 may include any wide area and/or local area network, such as the internet, a mobile communications network, a satellite network, a public service telephone network (PSTN) and/or other network for facilitating communication between devices. If the network 100 includes a local area network, the local area network may be configured as a communication path via Wi-Fi, Bluetooth, RFID, and/or other wireless protocol.

Accordingly, the user computing device 102 may include a personal computer, laptop computer, tablet, mobile communications device, database, and/or other computing device that is accessible by a user. The user computing device 102 may additionally include a memory component 140, which stores statistics logic 144a and crowd sourcing logic 144b, described in more detail below.

The remote computing device 104 is also coupled to the network 100 and may be configured as an online platform for accessing and/or contributing to predictions of various events, such as sporting events, stock market events, investment events, etc. As an example, sporting events may include football, baseball, basketball, soccer, swimming, horse racing, stock car racing, dog racing, golf, tennis, etc. Similarly, the administrator computing device 106 is coupled to the network 100 and may be utilized by an administrator to input statistical data related to the events that are being predicted by the remote computing device 104. As an example, an expert may determine statistical information on the administrator computing device 106 that is then sent to the remote computing device 104. Depending on the particular embodiment, the statistical data may be calculated by the human administrator or the administrator computing device 106. In some embodiments, the statistical data may be received and/or calculated by the remote computing device 104.

It should also be understood that while the user computing device 102, the remote computing device 104, and the administrator computing device 106 are each depicted as individual devices, these are merely examples. Any of these devices may include one or more personal computers, servers, laptops, tablets, mobile computing devices, data storage devices, mobile phones, etc. that are configured for providing the functionality described herein. It should additionally be understood that other computing devices may also be included in the embodiment of FIG. 1.

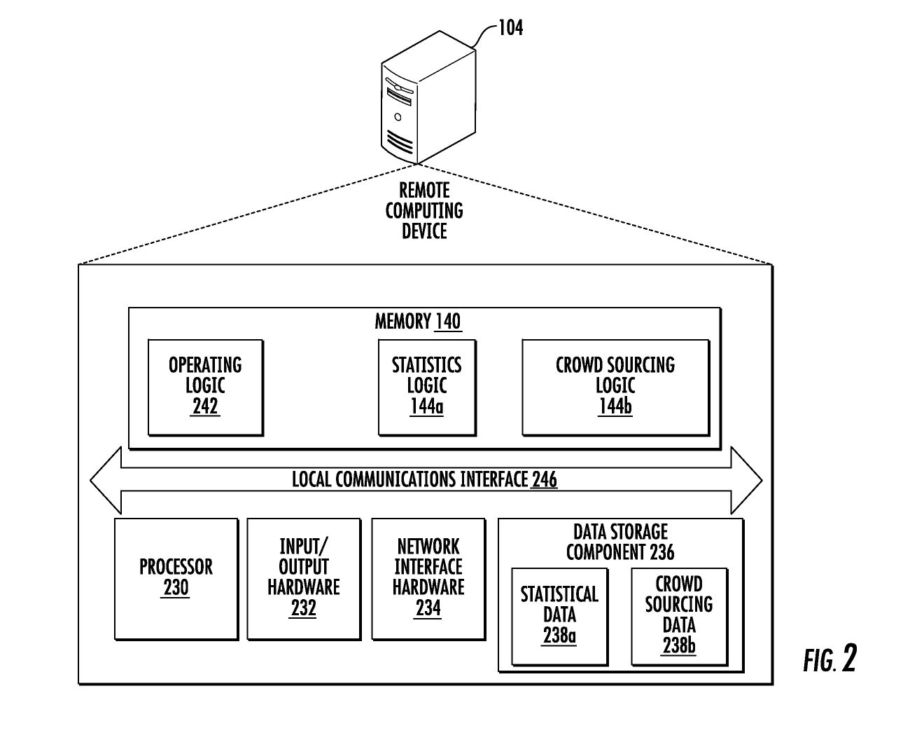

FIG. 2 depicts the remote computing device 104 for providing statistical and crowd sourced predictions, according to one or more embodiments shown and described herein. In the illustrated embodiment, the remote computing device 104 includes a processor 230, input/output hardware 232, network interface hardware 234, a data storage component 236 (which stores statistical data 238a and crowd sourced data 238b), and the memory component 140. The memory component 140 includes hardware and may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, the non-transitory computer-readable medium may reside within the remote computing device 104 and/or external to the remote computing device 104.

Additionally, the memory component 140 may be configured to store operating logic 242, the data capturing logic 144a, and the interface logic 144b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any hardware processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, RFID receiver, Bluetooth receiver, WiMax card, mobile communications hardware, and/or other hardware for communicating with other networks and/or devices.

It should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 236 may merely be a peripheral device, but external to the remote computing device 104.

Included in the memory component 140 are the operating logic 242, the statistics logic 144a, and the crowd sourcing logic 144b. The operating logic 242 may include an operating system and/or other software for managing components of the remote computing device 104. Similarly, the statistics logic 144a may be configured to cause the remote computing device 104 to utilize information regarding past events (such as player performance, team performance, etc.) to create a statistical model and/or predict outcomes for future performances for teams and/or players. The crowd sourcing logic 144b may cause the remote computing device 104 to collect prediction data from users of the remote computing device 104, as well as user biases, and other information. The crowd sourcing logic 144b may additionally cause the remote computing device 104 to provide an overall predication by utilizing both the crowd sourcing data and the statistical data.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104.

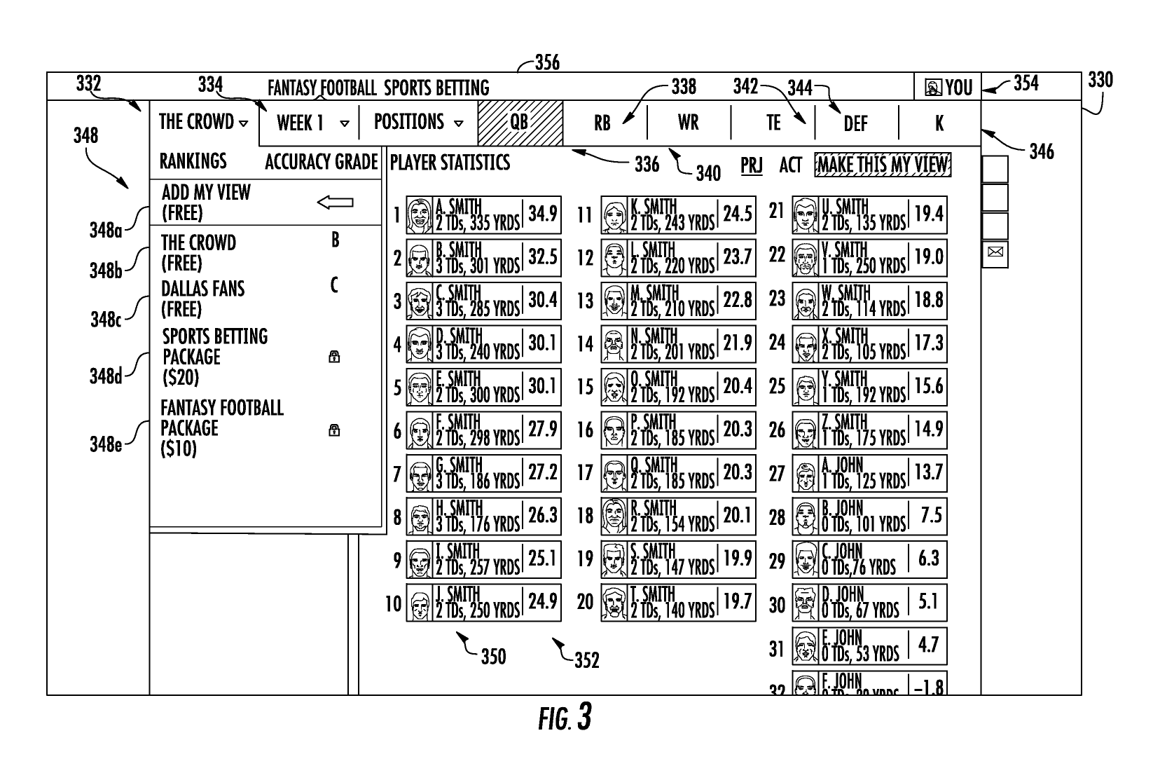

FIG. 3 depicts a user interface 330 for providing default player ratings, according to one or more embodiments shown and described herein. As illustrated, the user interface 330 includes a listing of a plurality of different players. The players may be ranked and/or rated, based on historical performance data. The rating a player receives may be determined based on a predetermined number of past events (such as the previous 16 games), which are subjected to a weighting algorithm that awards points according to predetermined performance statistics. As an example, player statistics may include pass percentage, fumble percentage, sack percentage, average gain, scoring average, save percentage, etc. Each of these statistics may be weighted and assigned a valued that is used to rate the player. If a certain statistic is determined to be less valuable at predicting future performance, that statistic will receive a lower weighting when determining the player's ranking. As discussed briefly above, this may be performed by a human expert, by a human expert via the administrator computing device 106, and/or via the remote computing device 104 utilizing the statistical logic 144a.

Also provided in FIG. 3 are a crowd option 332, a week option 334, a quarterback position option 336, a running back position option 338, a wide receiver position option 340, a tight end position option 342, a defense position option 344, and a kicker position option 346. In response to selection of the crowd option 334, the sub-options 348 may be provided. The sub-options 348 include an add my view sub-option 348a, a crowd sub-option 348b, a team specific sub-option 348c, an wagering sub-option 348d, and a fantasy sub-option 348e. In response to selection of the my view sub-option 348a, options may be provided that allow the user to rank the players for his/her account. In response to selection of the crowd sub-option 348b, the user may be provided with information related to the current crowd sourced rankings. As an example, the remote computing device 104 may compile the ranking of players and/or teams into a compilation of rankings, from one or more of the users that submitted rankings. Thus, by selecting the crowd sub-option 348b, the user may be provided with the compilation of the users' rankings.

It should be understood that in some embodiments, the crowd sourced ranking data may be provided as a simple average ranking for all or a subset of users. However in some embodiments, the remote computing device 104 may determine the most relevant aspects of the user rankings that provide the most accurate prediction of future performance and weight those aspects higher than other aspects. This may include not using one or more statistics in the ratings; not using some user's rankings; weighting some users higher than others; and/or performing other action to arrive at the most accurate crowd sourced data.

In response to selection of the team-specific sub-option 348c, only ranking data from fans of a predetermined team (or group) may be provided. As an example, if the user is a Dallas fan, the user may trust Dallas fans over other fans as having “inside information” regarding a team or player. Similarly, some teams' fans may simply be less biased and/or more accurate in their rankings (or vice versa). As such, ranking data from particular groups of users may be compiled and provided to the user.

In response to selection of the wagering sub-option 348d, enhanced wagering strategies may be provided to the user. These strategies may be derived from statistical expert data and/or crowd sourced data. In response to selection of the fantasy sub-option 348e, statistical and/or crowd sourced data that may assist the user in making fantasy football decisions may be provided.

Also included in the user interface 330 is a ranking of a plurality of players. The players may be ranked according to an administrator expert that utilizes statistical information to rank the players. In some embodiments however, the players may be ranked and/or rated by the remote computing device 104 and/or via other mechanism. Regardless, for each player depicted in the user interface 330, a statistics portion 350 and a rating are provided. The rating may be a fantasy rating, a rating determined from the ranking, and/or other type of rating. As also depicted, players at other positions may be provided via selection of the running back option 338, the wide receiver option 340, the tight end option 342, the defense option 344, and the kicker option 346. For different event types, different options may be provided for these rankings.

Also included are an account option 354 and a sports betting option 356. In response to selection of the account option 354, the user may log into an account with the remote computing device 104 and/or may otherwise access the user account, as described in more detail below. In response to selection of the sports betting option 356, information related to wagering on sporting events may be provided.

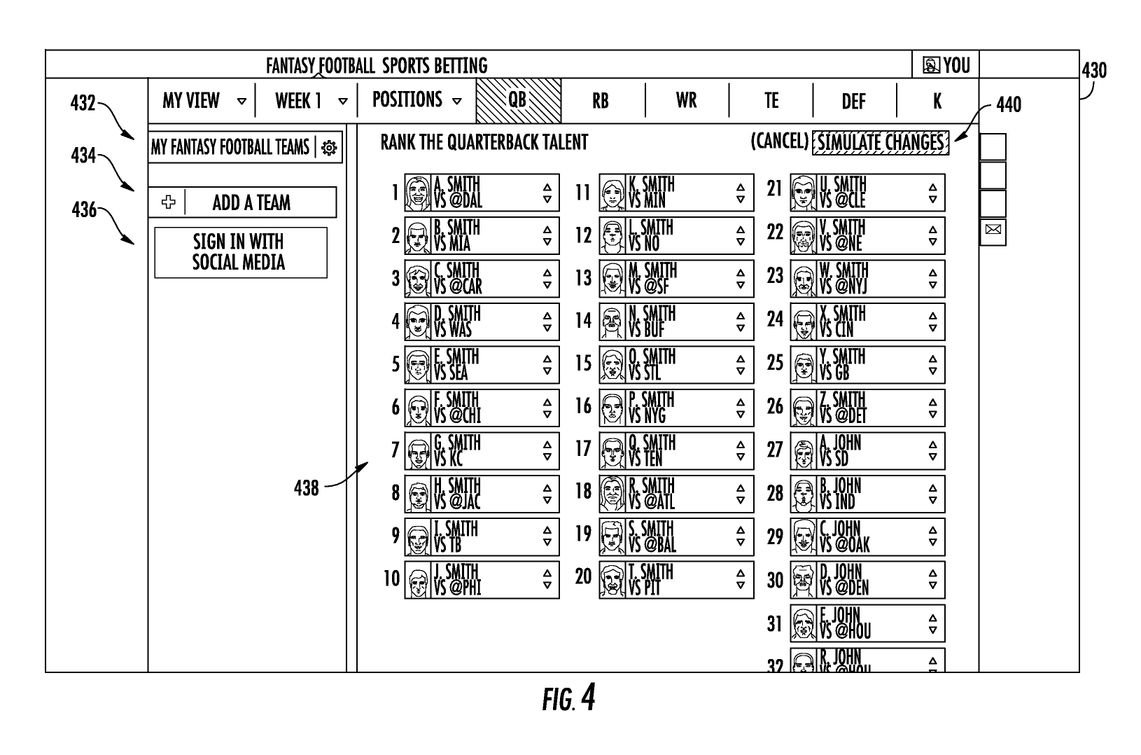

FIG. 4 depicts a user interface 430 for providing user ranking options for players, according to one or more embodiments shown and described herein. The user interface 430 may be provided in response to a user selection of the add my view option 348a from FIG. 3. As illustrated, the user interface 430 includes a my fantasy teams option 432, an add team option 434, and a social media option 436. In response to selection of the my fantasy football teams option 432, the user may be provided with options related to the players that are currently on the user's fantasy team. In response to selection of the add team option 424, options may be provided for the user to select the players on are on the user's fantasy team manually. In response to selection of the social media option 436, the user's fantasy team may be automatically loaded from a social media outlet with which the user has an account. Specifically, while selection of the add team option 434 allows the user to manually add his/her fantasy team (and/or other teams in his/her fantasy league), selection of the social media option 436 may automatically upload the user's fantasy team and/or league. By signing in with social media, updates to the league may be automatically uploaded as well.

Also provided in the user interface 420 are a ranking section 438 and a simulation option 440. The ranking section 438 is similar to the user interface 330 from FIG. 3, with the exception that the user may rank players of different positions. Specifically, the user may establish who the best quarterback is; who the second best is, etc. Based on these rankings, the remote computing device 104 may provide a rating for that player. In addition to ranking the starting players for each of plurality of positions, the user may also rank second string (substitute) players for those positions. As an example, the highest ranked starting player of a position may be provided with a rating equal to the highest ranked substitute player at that position. Other levels (third string, fourth string, etc.) of substitutes may also be ranked and rated.

Once the user has ranked one or more of the players according to his/her preference, the user may select the simulation option 440 to simulate the results of the rankings. Depending on the particular embodiment, selection of the simulation option 440 may cause the remote computing device 104 to perform a play-by-play simulation of a plurality of games with the players that have been ranked. The remote computing device 102 may make one simulation, or dozens, hundreds or thousands of simulations, depending on the embodiment. Additionally, other information may be utilized to simulate the games. As an example, the remote computing device 104 may utilize strategies of each of the teams, such as play calling, strengths, weaknesses, etc. As an example, if Team A passes more than an average team and Team B′s pass defense is worse than average, the simulations may take this into consideration when predicting the outcome of the games between Team A and Team B.

It should be understood that while some embodiment may be configured to simulate a game before the game has started, other embodiments are not so limited. As an example, some embodiments may be configured to provide and update predictions, as the game is progressing. Specifically, the remote computing device 104 may make predictions prior to a game. However the game itself may deviate from that prediction. As a result, the predictions and probabilities for outcome may change as the game progresses. As an example, if the remote computing device 104 determines that a first team will score 48 points in the first half, but after the first quarter, the first team has only scored 3 points, the remote computing device 102 may alter the prediction for the halftime score, the final score, and/or other predicted data. Additionally, remote computing device 104 may determine accuracy data of the original prediction, as well as alter the prediction algorithm, based on the reasons for the originally incorrect prediction. As such, embodiments described herein simulate a game play-by-play to provide predictions, not just on the outcome of the final score, but predictions based on which play may be run next, the predicted outcome of a particular play or possession, probabilities of success of a play or possession, and/or other data.

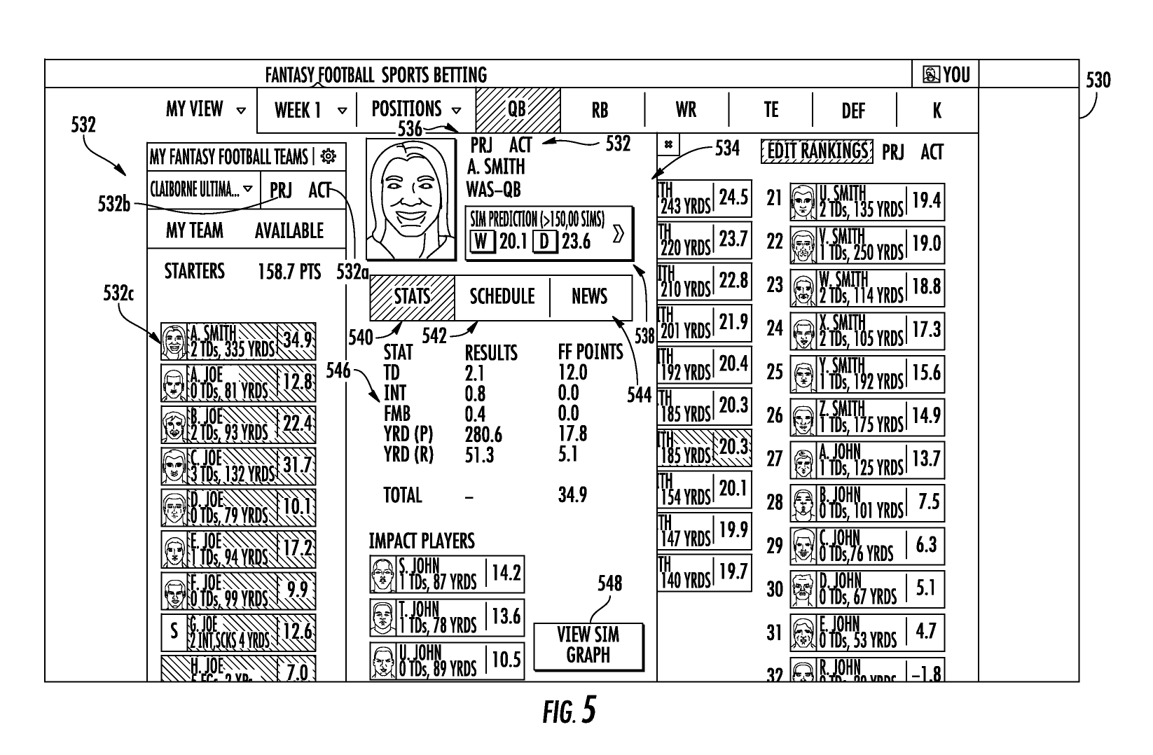

FIG. 5 depicts a user interface 530 for providing a prediction of a specific player, according to one or more embodiments shown and described herein. As illustrated, the user interface 530 includes a fantasy section 532 and a player section 534. The fantasy section 532 may provide the projected and actual ratings of the user's fantasy team and players. In response to selection of the actual fantasy option 532a, the user interface 530 may provide the current player and team ratings for the fantasy league with which the user has a team. In response to selection of the projected fantasy option 532b, the user interface 530 may provide a prediction of future performance for players and teams, based on historical statistical data, as well as rankings and ratings provided by users (crowd sourced data).

The user interface 530 may also provide other information, such as the ability to view available players for trades, other user's teams, current point totals, predicted point totals, etc. Also included are player options 532c. In response to selection of one of the player options 532c, the user interface 530 may provide the projected player section 534. The projected player section 534 includes a projected option 536a and an actual option 536b. The projected player section 534 also includes a game prediction section 538 that provides a prediction on the final score of the upcoming game in which the selected player is playing. This predicted final score may be determined by taking player rankings of each player on the two teams and utilizing those rankings to determine various team and sub-team ratings. With this information, the remote computing device 104 may simulate a game between the two teams several times (in some embodiments hundreds or thousands of times). These simulations may then be processed to determine a predicted final score.

Also included in the projected player section 534 are a statistics option 540, a schedule option 542, and a news option 544. In response to selection of the statistics option 540, the statistics 546 for that player and/or team may be provided. Since the player section in FIG. 5 is depicted as the projected player section 534, the statistics 546 that are provided may be predicted statistics, based on the user rankings, crowd sourced rankings, statistical ratings and/or other criteria.

Also included in the user interface 530 is a view simulated graph option 548. As discussed in more detail below, in response to selection of the view simulation graph option 548, a graphical representation of the simulated player and/or team performances may be plotted and utilized for further predictions.

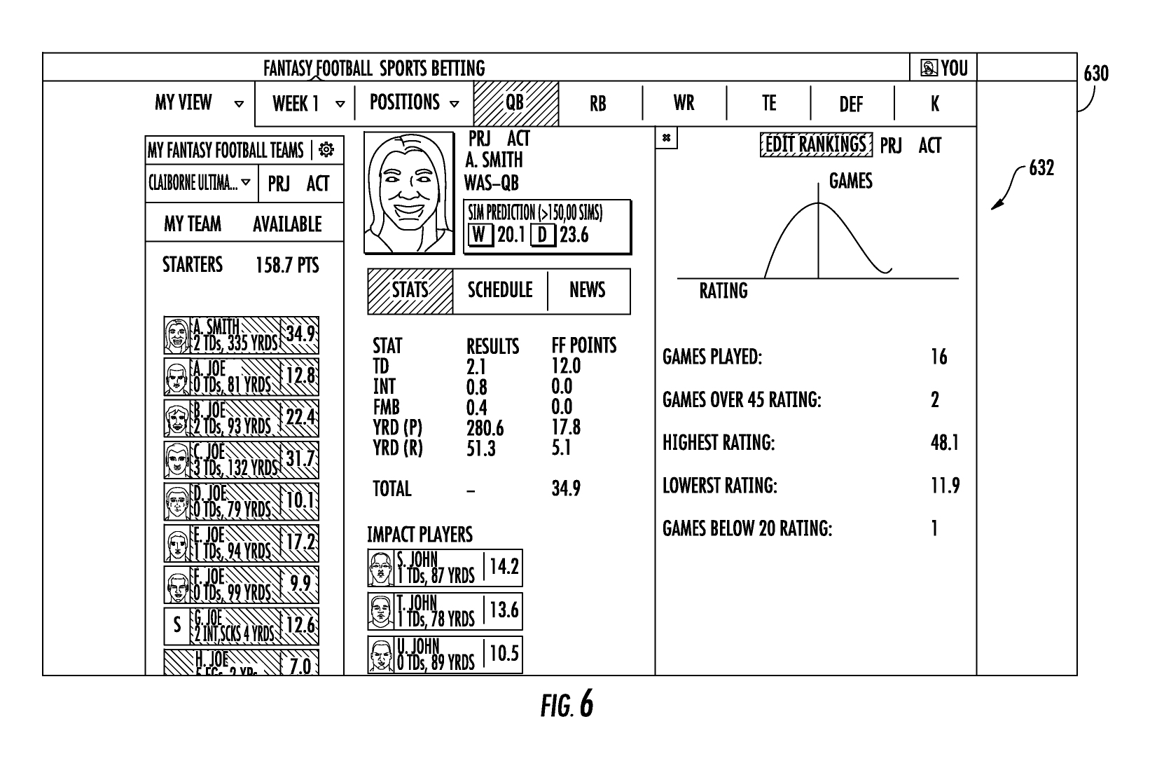

FIG. 6 depicts a user interface 630 for providing a player performance variance, according to one or more embodiments shown and described herein. In response to selection of the view simulation graph option 548 from FIG. 5, the user interface 630 may be provided. As illustrated, the user interface 630 is similar to the user interface 530 from FIG. 5, except that the user interface 630 includes a simulation area 632, which provides a graphical representation of at least a portion of the simulations that are run for the selected player. In the depicted example, the selected player played 16 games that are being considered (each with a different set of simulations). In those games, the player achieved a player ranking above a predetermined threshold twice. The player's highest rating was 48.1 and the lowest rating was 11.9. The player only had one game with a rating below a predetermined threshold.

In some embodiments, the simulation area 632 may provide the user with a consistency rating for a particular player or team. Specifically, some players may have very highly rated games and very low rated games. Such a player would thus have a wide performance curve. This information may be helpful to a user who needs a player for a fantasy team with a moderate ranking, but who may be capable of playing at a high level. Similarly, some users would prefer to acquire a consistent player, who does not play at as high a level, but will have very few bad games.

It should be understood that, while not explicitly depicted in FIG. 6, the simulation area may additionally provide a consistency rating and/or a peak rating to provide the user with a single indicator of the potential and/or consistency for a particular player or team. Other information, such as statistics from the outlying simulations, may also be provided, such that more sophisticated users may delve deeper into the projections.

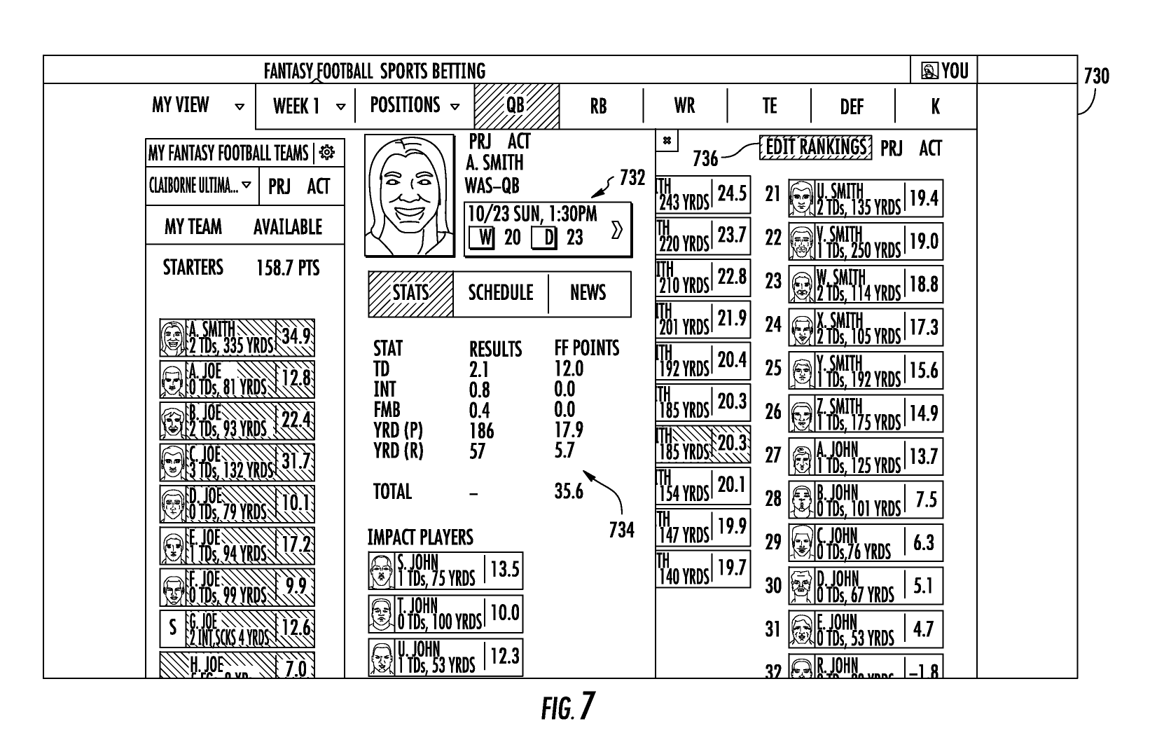

FIG. 7 depicts a user interface 730 for providing actual performance information of a player, according to one or more embodiments shown and described herein. In response to selection of the actual option 536b from FIG. 5, the user interface 730 may be provided with the actual current statistics for the selected player. As illustrated, the user interface 730 includes a game result section 732, which provides the actual score of a previously played game. Similar to the user interface 630 from FIG. 6, a statistics section 734 is also provided, which provides the actual statistics from the previously played game.

Also included in the user interface 730 from FIG. 7 is an edit rankings option 736. In response to selection of the edit rankings option 736, the user may be provided with the user interface 430 from FIG. 4 for altering the rankings of the players. As an example, a player may have a good game and the user may wish to upgrade that player's ranking. Similarly, the user may simply learn more about a player and decide to alter the ranking. This new ranking will be re-simulated for all players and teams to provide updated crowd sourced information.

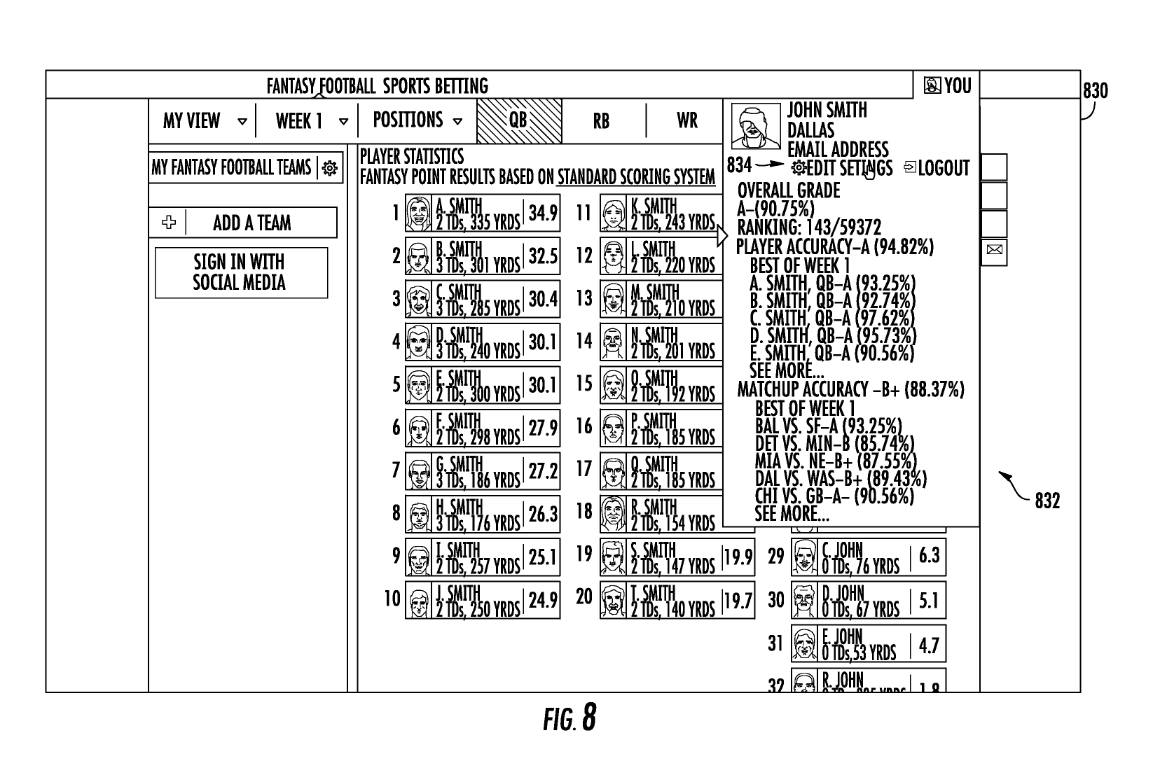

FIG. 8 depicts a user interface 830 for providing a user scorecard for player and team prediction, according to one or more embodiments shown and described herein. In response to selection of the account option 354 from FIG. 3, the account section 832 may be provided. The user section 832 includes an edit settings option 834, as well as information regarding the user and the user's ranking accuracy. In response to selection of the edit settings option 834, the user may select their favorite team, set passwords, addresses, user names, etc. Additionally, the user section 832 provides a user grade, a user ranking, and other information related to the prediction accuracy by the user. As discussed above, the user may rank players based on position and, based on the results of the following games, that ranking may be compared with the actual performance of those players. An accuracy percentage may then be determined and provided to the user. The user section 832 may also provide which players were ranked by the user most accurately as well as which games were predicted by the user most accurately. With this information, the remote computing device 104 and/or administrator may determine which users are best at predicting outcomes of games. Those users may be incentivized to continue providing predictions, such as through payment, greater access to the website, and/or via other incentives.

Additionally, the accuracy data may be utilized by the remote computing device 104 to determine which pieces of information were most helpful in accurately predicting an outcome of a game. As an example, if the remote computing device 104 determines that the highest rated users focus primarily on quarterback proficiency, the statistical model used to predict results may be altered to weigh quarterback performance higher. Additionally, some embodiments are configured to provide this information to other users to know which statistics provide the greatest probability for predictive success.

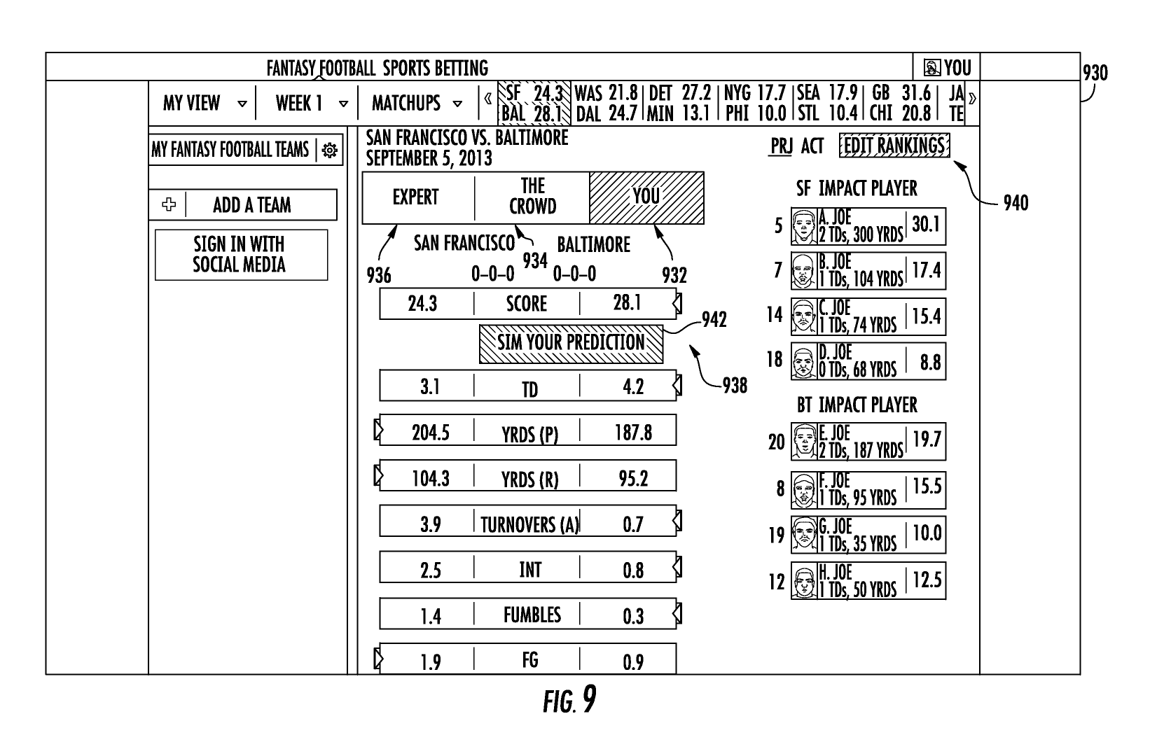

FIG. 9 depicts a user interface 930 for simulating a game based on user rankings, according to one or more embodiments shown and described herein. In response to selection of the fantasy option 348e from FIG. 3, the user interface 930 may be provided. As illustrated, the user interface 930 includes a user option 932, a crowd option 934, and an expert option 936. Specifically, after selection of the user option 932, the statistics section 938 may be provided. The statistics in the statistics section 938 may be determined based on the user's rankings of the players, and/or other information, as described in more detail below. As an example, if the user ranks the Baltimore offense as the highest ranked and San Francisco's defense as the lowest ranked, such rankings would help determine the predicted points that Baltimore will likely score. As discussed above, the remote computing device 104 may run a plurality of simulations, based on these rankings. An aggregate of the simulations may be utilized to determine the predicted result.

In some embodiments, the aggregate may simply be an average of all simulations. Some embodiments may aggregate the simulations by removing outlier simulations and averaging the remaining simulations. Some embodiments may be configured to utilize results of past games and/or predictions to determine the most accurate mechanism for aggregating the simulations. As an example, if the most accurate simulations of Team A occurred when Player B performed highly, a weighting of those games may be made in the aggregation.

Also included in the example of FIG. 9 are an edit rankings option 940 and a simulation option 942. As discussed above, the user may select the edit rankings option 940 for changing player rankings and/or other rankings. In response to editing the user rankings and/or selecting the simulation option 942, the simulations may be re-run to account for the changes.

As an example, some embodiments may be configured to allow the user to manually edit the predicted statistics depicted in the statistics section 938. Specifically, the statistics provided in the statistics section 938 are determined based on the simulations using the player rankings provided by the user. If the user feels that the score will be different, some embodiments are configured to provide an option for the user to manually change the score. If the user feels that the yards or other statistic will be different, the user may alter the desired statistic and select the simulation option 942 to recalculate the final score (and/or other statistics).

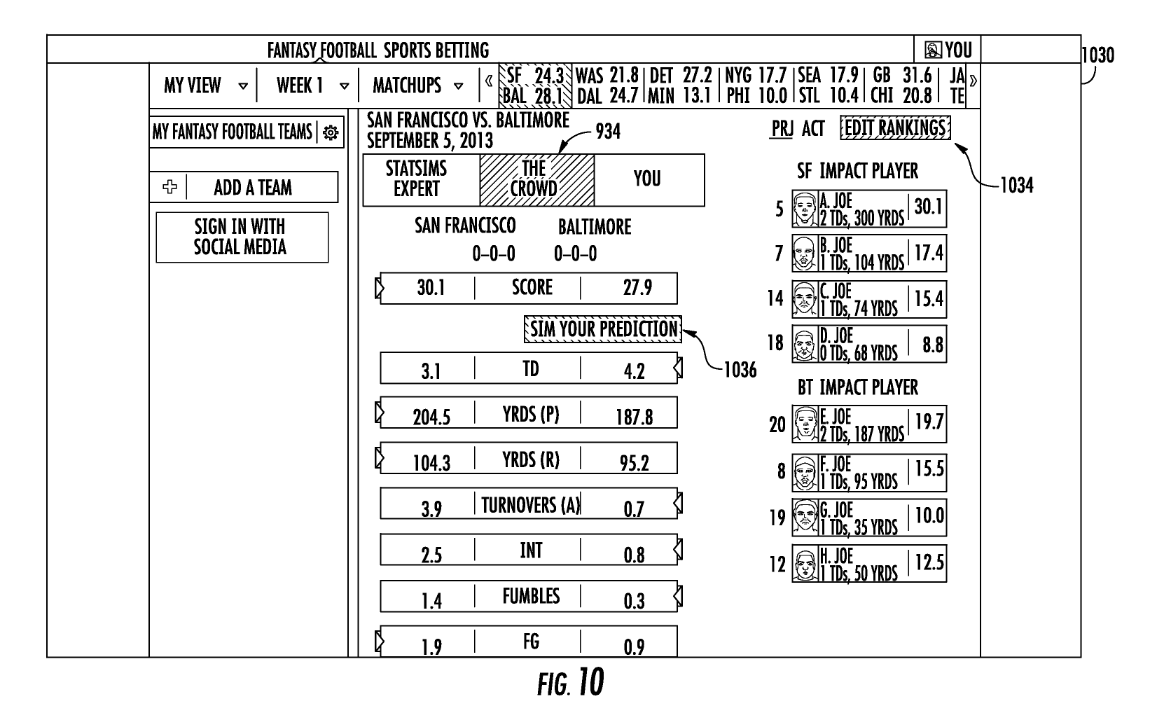

FIG. 10 depicts a user interface 1030 for simulating a game based on crowd sourcing, according to one or more embodiments shown and described herein. In response to selection of the crowd option 934 from FIG. 9, the user interface 1030 is provided. As illustrated, the user interface 1030 provides projected results that have been predicted via the crowd sourced data. As discussed above, the remote computing device 104 may compile rankings from a plurality of users and use this information to create a more accurate prediction model. Also included in the user interface 1030 are an edit rankings option 1034 and a simulation option 1036. As discussed above, in response to selection of the edit rankings option 1034, the user may be provided with options to edit his/her player rankings and/or other selections. Similarly, selection of the simulation option 1036 re-simulates the user's selections for including into the crowd sourced data.

It should be understood that while the crowd sourced data may include predictions and data from all users of the system, this is merely an example. Depending on the user's selections and the particular embodiment, the crowd sourced data may be taken from a subset of all users, such as fans of a particular team, users that have grouped themselves together, users from a predetermined location, users with a prediction score above a predetermined threshold, etc.

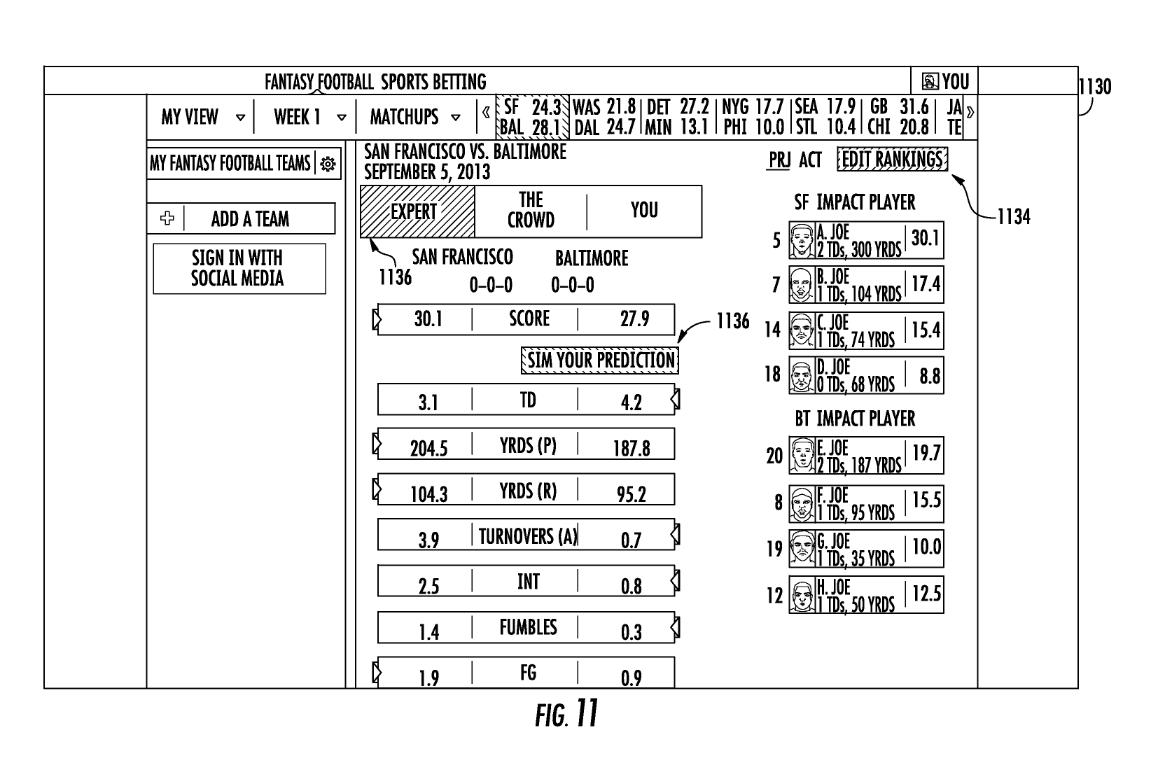

FIG. 11 depicts a user interface 1130 for simulating a game based on statistical analysis, according to one or more embodiments shown and described herein. In response to selection of the expert option 936 from FIG. 9, the user interface 1130 may be provided, which includes game predictions, based on expert and statistical data. Specifically, embodiments disclosed herein may be configured to analyze statistical data from past performances of players and teams. Based on the historical statistical data, the remote computing device 104 may determine which statistics to weigh more than other statistics, as well as a mechanism for altering the prediction algorithm, based on successful predictions by the remote computing device 102, the crowd sourced predictions, or elsewhere. Similar to the user interfaces 930 and 1030 from FIGS. 9 and 10, respectively, the user interface 1130 includes an edit rankings option 1134 and a simulation option 1136.

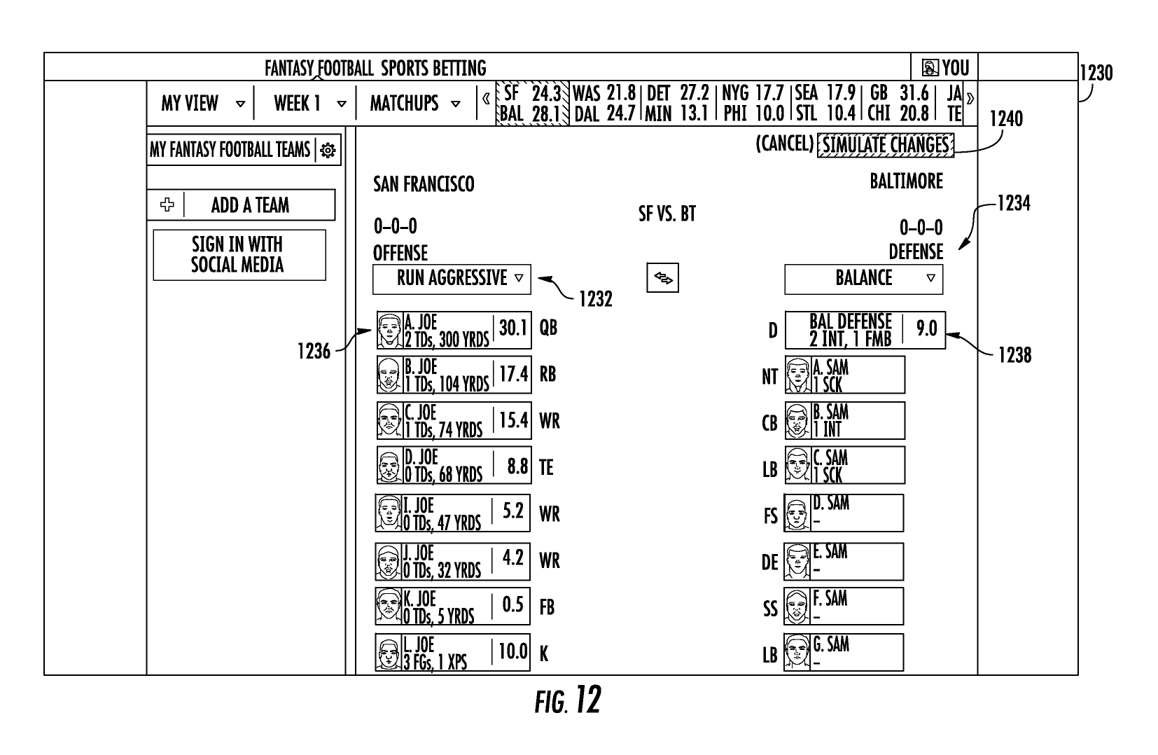

FIG. 12 depicts a user interface 1230 for simulating a game based on user predicted strategies, according to one or more embodiments shown and described herein. In response to selection of the edit rankings options 934, 1034, and/or 1134 from FIGS. 9, 10, and 11, the user interface 1230 may be provided. The user interface 1230 may depict a matchup between a plurality of teams and includes a listing of the starting players on each team. In response to selection of one of the edit options 1236, 1238, the user may alter the rankings of one or more of the players. In response to selection of the play calling option 1232 and/or 1234, the user may select the type of offense, defense, or other strategy that a team is predicted to play. Upon setting the desired player rankings, strategy, and selecting the simulation option 1240, the remote computing device 104 will re-simulate the data and return to the user interface 930 from FIG. 9 to provide the updated prediction.

Some embodiments may also include a player performance option, for the user to indicate whether a player will have a hot streak, a cold streak, or perform as in the past. As an example, if the user feels that a certain player will have a great game, he may indicate this hot streak in the player performance option. Similarly, a user may learn that a player has a minor injury, but will still play. As such, the player may indicate that the player will have a cold streak for this game or for a predetermined number of games. Based on the user indications via the player performance option, the player's temporary ranking may change, as well as the predicted outcome of the game, the use of substitute players for that player, etc.

It should also be understood that embodiments described herein may be configured to determine the types of plays that a team will run. As an example, if the teams are football teams, the remote computing device 104 may access historical data (such as a predetermined number of past games) on the teams to determine the percentage of running plays for first down at a first field location, second down, for a second field location, etc. This play calling analysis may be utilized to further predict the outcome of the game. As an example, if a team is primarily a running team and is playing the best run defense in the league, this will affect the outcome of the game. Additionally, in response to the user selection of “pass aggressive” on the play calling option 1232 the prediction of that team's strategy will be altered, thus likely affecting the outcome of the game.

Depending on the embodiment, the play calling option 1232 may take any of a plurality of different forms. As an example, some embodiments may provide the user with the simple interface depicted in FIG. 12, with “run aggressive,” pass aggressive,” and “balance” options for offense and similar options for defense. However, some embodiments may be configured for the user to identify exactly in which situations a team will call which type of plays. As an example, these embodiments may provide a user interface with options such as “first down, own 20 pass” and provide a field for the user to identify the percentage of plays that will be pass plays. Other options may be “first down, own 20 run,” “second down, own 20 pass,” etc. This level of freedom provides an advanced user the ability to specify the exact plays or types of plays that he/she predicts will be run for many or all game situations. In at least one of these embodiments, these fields may be automatically populated, based on the predictions made by the remote computing device 104 or crowd.

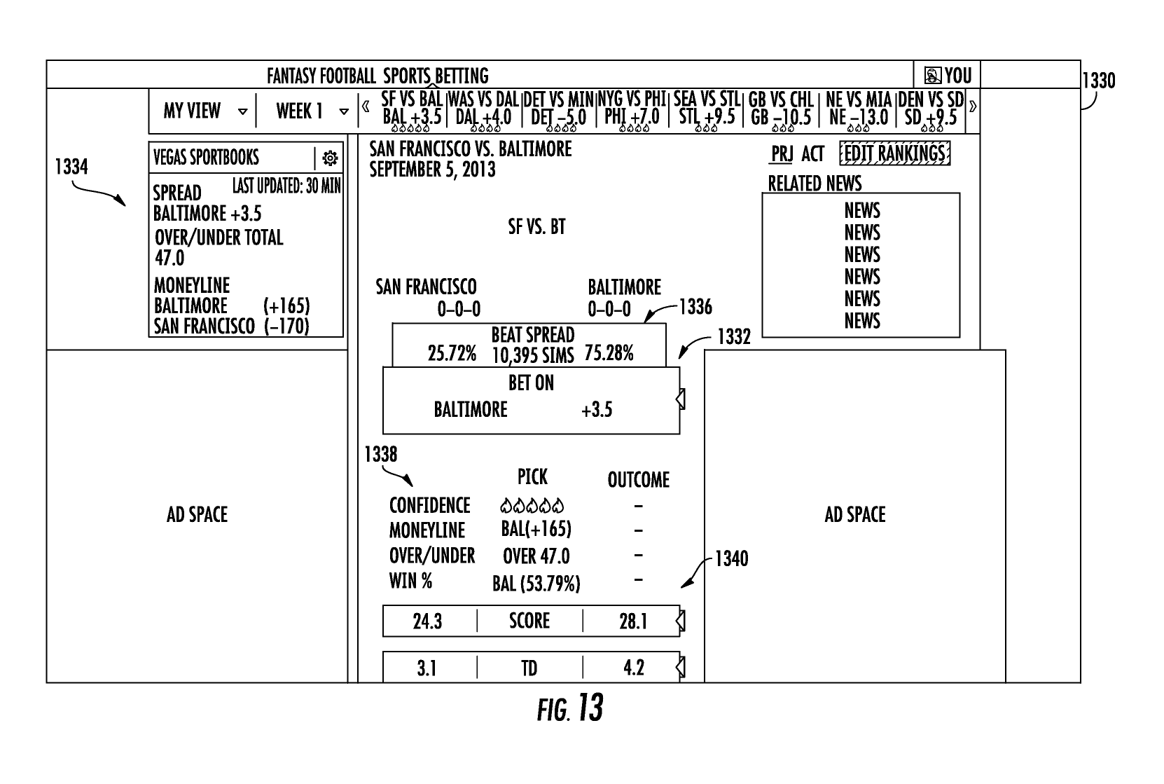

FIG. 13 depicts a user interface 1330 for providing wagering predictions for a game, according to one or more embodiments shown and described herein. In response to selection of the sports betting option 356 from FIG. 3, the user interface 1330 may be provided. The user interface 1330 includes a wagering section 1332, a sports book section 1334, a confidence section 1336, a confidence details section 1338, and a statistics section 1340. Specifically, the wagering section 1332 provides an indication of on which team the user should place a wager, based on the spread. Specifically, many sports books determine the expected outcome of a game and determine the spread, based on that predicted outcome. As illustrated in the user interface 1330, the spread of the depicted example is provided in the sports book section 1334. In the example of FIG. 13, the sports book indicated that predicted that San Francisco would beat Baltimore by 3.5 points. Accordingly, embodiments disclosed herein predict the outcome of the game, based on statistical data and crowd sourced data. Based on this prediction, the remote computing device 104 may compare this prediction to the spread to determine on which team the user should wager.

Additionally, the confidence section 1336 includes a percentage of predicted accuracy of the betting strategy that is provided in the wagering section 1332. This is determined based on the simulations and the number of simulations that agreed with the prediction versus the number of predictions that disagreed with the prediction. Specifically, based on the players' consistency rating and thus the teams' consistency rating, simulations may be such that different teams win a game, based on the simulation. As a result, the remote computing device 104 may predict an outcome of a game, based on the simulation, but that choice may have more uncertainty, depending on the consistency factor and/or other data related to the teams.

Similarly, the confidence details section 1338 provides additional insight and wagering strategies, based on the simulations. As an example, the remote computing device 104 may provide betting strategies, such as suggesting a wager on a final score, a money line wager, and an over-under wager, etc. The statistics section 1340 provides the predicted score and statistics, based on the simulations.

It should be understood that some embodiments may be configured for the user to actually place wagers on the game, based on the prediction and the spread data of FIG. 13. While some embodiments may provide these wagering options within the user interface 1330, some embodiments may provide a link to an external website for wagering. Regardless, these embodiments may be configured to track the user's wagers to determine which predictions yield the best wagers and/or provide other information related to the wager.

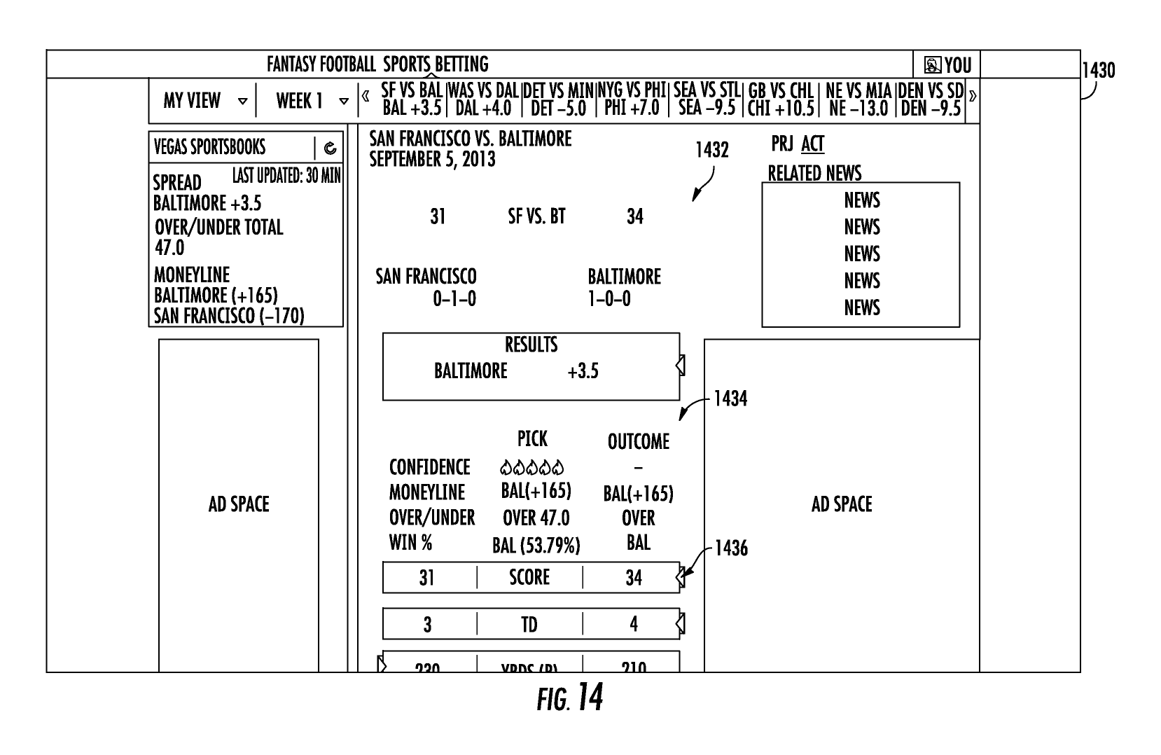

FIG. 14 depicts a user interface 1430 for providing wagering results for a past game, according to one or more embodiments shown and described herein. After the game has been played, the user interface 1430 may be provided to indicate the accuracy of the predictions made prior to the game. As illustrated, the user interface 1430 provides a results section 1432, a results details section 1434, and a statistics section 1436. The results section 1432 provides the final score of the game, the current records of the teams, and the spread at the time of the wager. In the results details section 1434, the outcome column is populated, indicating which of the listed wagers were accurate. The statistics section 1436 provides the actual statistics of the game.

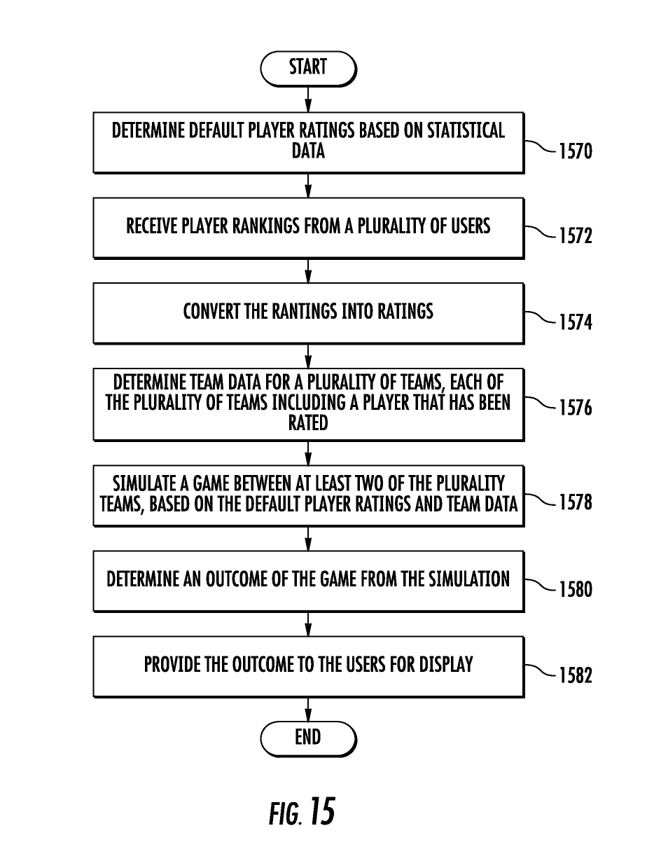

FIG. 15 depicts a flowchart for simulating a game based on statistical data and crowd sourcing data, according to one or more embodiments shown and described herein. As illustrated in block 1570, default player ratings may be determined based on statistical data. As discussed above, the default player ratings may be provided by an administrator, determined by the remote computing device 104 based on statistics from previous games, and/or may be a compilation of the crowd sourced rankings. In block 1572, user player rankings may be received from a plurality of users. In block 1754, the user player rankings may be converted into user ratings. Based on where a particular user ranks player, the remote computing device 104 determines the assigned rating of that player. Additionally, certain corrections may be made by the remote computing device 102 to the ratings, based on which team that the user is a fan, the user's location, the user's previous ranking history, the user's wagering history, and/or other data. In block 1576, team data for a plurality of teams may be determined, where each of the plurality of teams includes a player that has been rated. As an example, based on the user rankings of players, and thus the player ratings, a team may be rated for offense, defense, special teams, overall performance, and/or for other purposes. In block 1578, a game between at least two of the plurality of teams may be simulated, based on the default player ratings, the user ratings, and the team data. In block 1580 an outcome of the game may be determined based on the simulation. In block 1582, the outcome may be provided to the users for display.

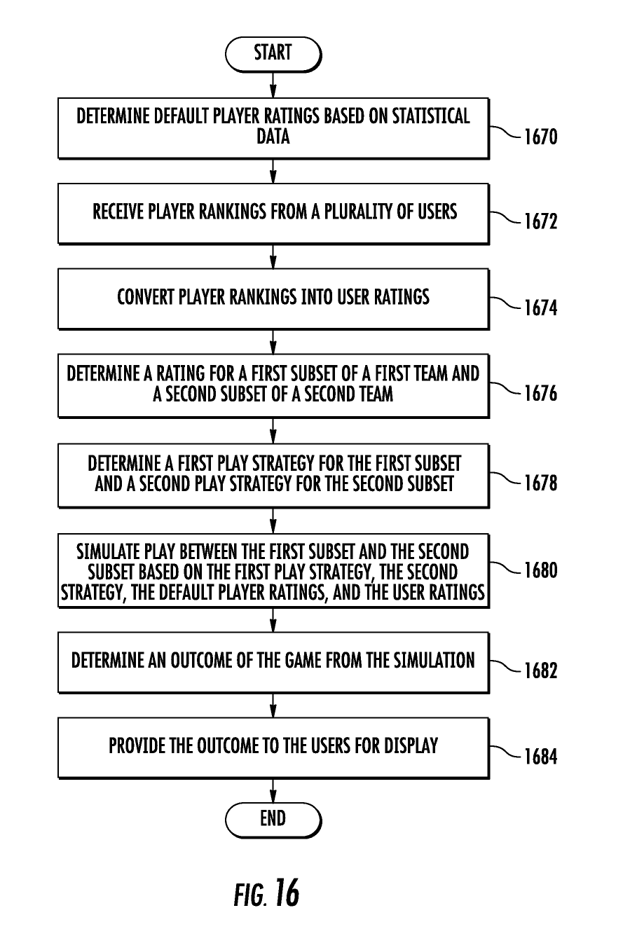

FIG. 16 depicts a flowchart for simulating a portion of a game, based on performance in that game, according to one or more embodiments shown and described herein. As illustrated in block 1670, default player ratings may be determined based on statistical data. In block 1672, user player rankings may be received from a plurality of users. In block 1674, the user player rankings may be converted into user ratings. In block 1676, a rating for a first subset of a first team and a second subset of a second team may be determined. The subsets may be for an offense, a defense, a kicking team, a special team, a starting team, a substitute team, and/or other subsets, depending on the teams, the sports, and/or other data. In block 1678, a first play strategy for the first subset and a second play strategy for the second subset may be determined. In block 1680, a game between the first subset and the second subset may be simulated based on the first play strategy, the second play strategy, the default player ratings, and the user ratings. In block 1682, an outcome of the game may be determined from the simulation. In block 1684, the outcome may be provided to the users for display.

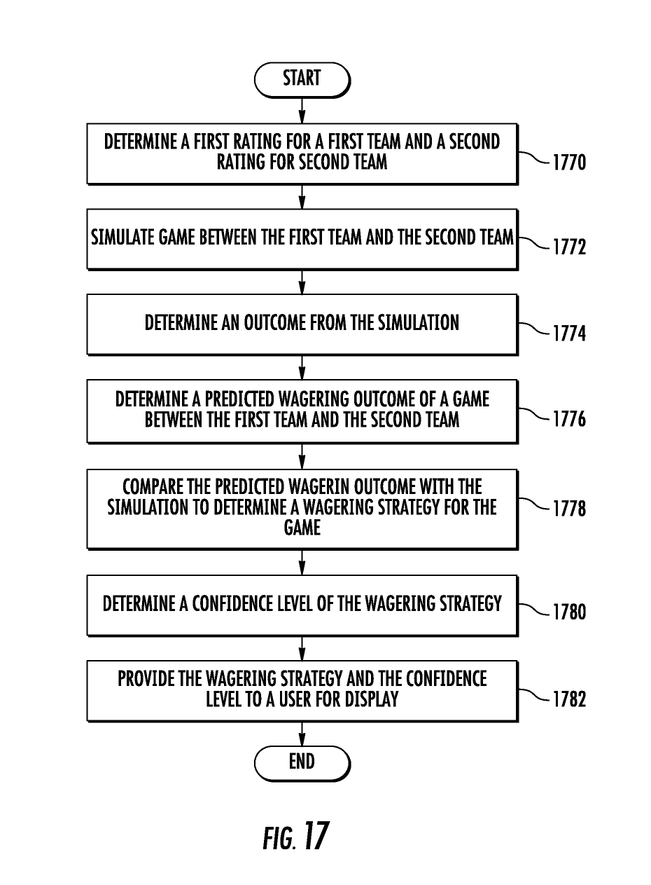

FIG. 17 depicts a flowchart for determining a wagering strategy for a game, according to one or more embodiments shown and described herein. As illustrated in block 1770, a first rating for a first team and a second rating for a second team may be determined. In block 1772, play between the first team and the second team may be simulated. In block 1774, an outcome from the simulation may be determined. In block 1776, a predicted wagering outcome of a game between the first team and the second team may be determined. In block 1778, the predicted betting outcome may be compared with the simulation to determine a wagering strategy for the game. In block 1780, a confidence level of the wagering strategy may be determined. In block 1782, the wagering strategy and the confidence level may be provided to a user for display.

As discussed above, embodiments described herein provide both crowd sourcing and statistical predictions to determine a predicted outcome to a game, match, or other event. To this end, embodiments provide the ability to simulate the event play-by-play to predict every occurrence in the event, as well as provide wagering strategies for various outcomes of the event. This provides a greater prediction capabilities, as well as better wagering accuracy.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for providing statistical and crowd sourced predictions, comprising:
a processor; and
a memory component that is coupled to the processor, the memory component storing logic that, when executed by the processor, causes the system to perform at least the following:
determine default player ratings for a plurality of players based on statistical data;
receive user player rankings from a plurality of users;
convert the user player rankings into user ratings;
determine team data for a plurality of teams, wherein each of the plurality of teams includes a player that has been rated;
simulate a game between at least two of the plurality of teams, wherein the simulation is made based on the default player ratings, the user ratings, and the team data;
determine an outcome of the game from the simulation; and
provide the outcome to the plurality of users for display.

2. The system of claim 1, wherein the logic further causes the system to perform at least the following:
determine a spread of the game;
determine a wagering strategy, wherein the wagering strategy is determined from the simulation and the spread; and
provide the wagering strategy to at least one of the plurality of users.

3. The system of claim 1, wherein the simulation is a play-by-play simulation of the game.

4. The system of claim 1, wherein an actual performance of the game between at least two of the plurality of teams occurs and wherein the simulation changes, based on an outcome of the actual performance of the game.

5. The system of claim 1, wherein the logic further causes the system to determine a consistency factor of at least one of the plurality of players.

6. The system of claim 1, wherein determining the outcome comprises determining at least one of the following: a final score of the game, a halftime score of the game, a play that was run during the game, success of a play that was run during the game, and success of a possession.

7. The system of claim 1, wherein the user ratings comprise at least one of the following:
a compilation of rankings from all users and a compilation of rankings from a predetermined subset of users.

8. A method for providing statistical and crowd sourced predictions, comprising:
determining default player ratings based on statistical data;
receiving player rankings from a plurality of users;
converting the player rankings into user ratings;
determining a rating for a first subset of a first team and a second subset of a second team;
determining a first play strategy for the first subset and a second play strategy for the second subset;
simulating a game between the first subset and the second subset based on the first play strategy, the second play strategy, the default player ratings, and the user ratings;
determining an outcome of the game from the simulation; and
providing the outcome to the plurality of users for display.

9. The method of claim 8, wherein the first subset comprises at least one of the following:
an offense, a defense, a kicking team, a special team, a starting team, and a substitute team.

10. The method of claim 8, wherein determining the first play strategy comprises at least one of the following: pass aggressive offense, run aggressive defense, and balanced.

11. The method of claim 8, further comprising:
determining a spread of the game;
determining a wagering strategy, wherein the wagering strategy is determined from the simulation and the spread; and
providing the wagering strategy to at least one of the plurality of users.

12. The method of claim 8, wherein the simulation is a play-by-play simulation of the game.

13. The method of claim 8, wherein an actual performance of the game between the first team and the second team occurs and wherein the simulation changes, based on an outcome of the actual performance of the game.

14. The method of claim 8, wherein determining the outcome comprises determining at least one of the following: a final score of the game, a halftime score of the game, a play that was run during the game, success of a play that was run during the game, and success of a possession.

15. A non-transitory computer-readable medium for providing statistical and crowd sourced predictions that stores logic, that when executed by a computing device, causes the computing device to perform at least the following:
determine a first rating for a first team and a second rating for a second team;
simulate a game between the first team and the second team;
determine an outcome from the simulation;
determine a predicted wagering outcome of the game between the first team and the second team;
compare the predicted wagering outcome with the simulation to determine a wagering strategy for the game;
determine a confidence level of the wagering strategy; and
provide the wagering strategy and the confidence level to a user for display.

16. The non-transitory computer-readable medium of claim 15, wherein determining the predicted wagering outcome comprises determining a wager for at least one of the following: a wager on a final score, a money line wager, and an over-under wager.

17. The non-transitory computer-readable medium of claim 15, wherein the logic further causes the computing device to perform a plurality of simulations and wherein the confidence level is determined from an outcome of at least one of the plurality of simulations.

18. The non-transitory computer-readable medium of claim 15, wherein the simulation is a play-by-play simulation of the game.

19. The non-transitory computer-readable medium of claim 15, wherein determining the outcome comprises determining at least one of the following: a final score of the game, a halftime score of the game, a play that was run during the game, success of a play that was run during the game, and success of a possession.

20. The non-transitory computer-readable medium of claim 15, wherein the logic further causes the computing device to determine a consistency factor of at least one of a plurality of players.
